(19) United States
(12) Patent Application Publication
(10) Pub. No.: US 2026/0336517 A1
(43) Pub. Date: Oct. 29, 2026

(54) REARVIEW ELEMENT FOR AN ELECTRO-OPTIC REARVIEW MIRROR ASSEMBLY

(71) Applicant: Gentex Corporation, Zeeland, MI (US)

(72) Inventors: Eric S. Lundy, Holland, MI (US); Nigel T. Lock, Holland, MI (US); Richard T. Fish, Jr., Hudsonville, MI (US); Matthew A. Koppey, West Olive, MI (US); Gregory A. Herrema, Grandville, MI (US)

(73) Assignee: Gentex Corporation, Zeeland, MI (US)

(21) Appl. No.: 19/487,346

(22) PCT Filed: Apr. 15, 2025
(86) PCT No.: PCT/IB2025/053957

§ 371 Date: Nov. 24, 2025

Related U.S. Application Data
(60) Provisional application No. 63/634,812, filed on Apr. 16, 2024.
(60) Provisional application No. 63/695,214, filed on Sep. 16, 2024.

(51) Int. Cl. B60R 1/08; B60R 1/04; G02F 1/153

(52) U.S. Cl. CPC B60R 1/088; B60R 1/04; G02F 1/153

(57) ABSTRACT

An electro-optic rearview mirror assembly including a rearview element including a perimeter surface formed from the combination of, moving rearward from the intended viewer, (a) a forward glass portion provided by a forward glass substrate, (b) a forward polymer portion provided by a forward polymer substrate, (c) a forward electrochromic portion provided by a forward electrochromic substrate, (d) a rearward electrochromic portion provided by a rearward electrochromic substrate, (e) a rearward polymer 2025/219885 portion provided by a rearward polymer substrate disposed, and (f) a rearward glass portion provided by a rearward glass substrate. The perimeter surface has a contoured portion where moving rearward from the forward polymer portion, each subsequent portion is substantially flush with preceding portion. The contoured portion of the perimeter surface is exposed to an external environment and the electro-optic rearview mirror assembly lacks an element covering the contoured portion.

### CROSS-REFERENCE TO RELATED APPLICATIONS

This application claims priority to and the benefit under 35 U.S.C. § 119(e) of U.S. Provisional Application No. 63/634,812 filed on 16 Apr. 2024, entitled ELECTRO-OPTIC REARVIEW MIRROR ASSEMBLY and U.S. Provisional Application No. 63/695,214 filed on 16 Sep. 2024, entitled REARVIEW ELEMENT FOR AN ELECTRO-OPTIC REARVIEW MIRROR ASSEMBLY, the disclosures of which are hereby incorporated herein by reference in their entirety.

### TECHNICAL FIELD

The present disclosure pertains to a rearview element for an electro-optic rearview mirror assembly and, more particularly, to a rearview element including a perimeter surface that is contoured and exposed to an external environment.

### BACKGROUND

Some vehicles are equipped with a rearview mirror. The rearview mirror provides an operator of the vehicle with a view rearward of the rearview mirror, including in some instances rearward of the vehicle. Some rearview mirrors include a variable transmittance element over a reflective element. The variable transmittance element allows the rearview mirror to adjust reflectance back to the operator as a function of incident light, to reduce the level of glare that the operator perceives. The variable transmittance element is sometimes an electro-optic element. Such rearview mirrors sometimes include display elements to provide information of various sorts to the operator. Rearview mirrors include a housing, bezel, or some other structure that covers a peripheral edge of the variable transmittance and reflective elements.

However, there is a problem in that the housing, bezel, or other structure can be aesthetically displeasing and adds suboptimal manufacturing expense and time.

### SUMMARY

The present disclosure addresses the problem, among other things, with a rearview element that has a perimeter surface between primary forward and rearward facing surfaces that is contoured and exposed to the external environment (e.g., not covered by a housing). The perimeter surface can be ground to achieve the desired contour. At a seal for the electrochromic medium, the portion of the perimeter surface formed by the seal is an electrically insulative material. The electrically insulative material is disposed outward of a metallic strip so as to prevent the metallic strip from being exposed to the external environment and thus visible. The contour of the rearview element and the hidden metallic strip are more optimal from an aesthetic point of view.

According to an aspect of the present disclosure, an electro-optic rearview mirror assembly comprises: a rearview element comprising: (a) a perimeter surface; (b) a forward electrochromic substrate having a forward primary surface and a rearward primary surface, the forward electrochromic substrate forming a forward electrochromic portion of the perimeter surface; (c) a rearward electrochromic substrate having a forward primary surface and a rearward primary surface, the rearward electrochromic substrate forming a rearward electrochromic portion of the perimeter surface; (d) an electrochromic medium sandwiched between the forward electrochromic substrate and the rearward electrochromic substrate; (e) a forward polymer substrate disposed forward of the forward electrochromic substrate, the forward polymer substrate forming a forward polymer portion of the perimeter surface, the forward polymer substrate contacting and at least partially covering the forward primary surface of the forward electrochromic substrate, the forward polymer substrate comprising a forward primary surface and a rearward primary surface facing away from forward primary surface of the forward polymer substrate and facing the forward primary surface of the forward electrochromic substrate; (f) a forward glass substrate disposed forward of the forward polymer substrate, the forward glass substrate forming a forward glass portion of the perimeter surface, the forward glass substrate contacting and at least partially covering the forward primary surface of the forward polymer substrate, the forward glass substrate comprising a forward primary surface and a rearward primary surface facing away from the forward primary surface of the forward glass substrate and facing the forward primary surface of the forward polymer substrate layer; (g) a rearward polymer substrate disposed rearward of the rearward electrochromic substrate, the rearward polymer substrate forming a rearward polymer portion of the perimeter surface, the rearward polymer substrate contacting and at least partially covering the rearward primary surface of the rearward electrochromic substrate, the rearward polymer substrate comprising a forward primary surface facing the rearward primary surface of the rearward electrochromic substrate and a rearward primary surface facing away from the forward primary surface of the rearward polymer substrate; and (h) a rearward glass substrate disposed rearward of the rearward polymer substrate, the rearward glass substrate forming a rearward glass portion of the perimeter surface, the rearward glass substrate contacting and at least partially covering the rearward primary surface of the rearward polymer substrate, the rearward glass substrate comprising a forward primary surface facing the rearward primary surface of the rearward polymer substrate and a rearward primary surface facing away from the forward primary surface of the rearward glass substrate; wherein, the perimeter surface has a contoured portion where (i) the forward polymer portion is substantially flush with the forward electrochromic portion, (ii) the forward glass portion is substantially flush with the forward polymer portion, (iii) the rearward polymer portion is substantially flush with the rearward electrochromic portion, and (iv) the rearward glass portion is substantially flush with the rearward polymer portion, and wherein, the contoured portion of the perimeter surface is exposed to an external environment and the electro-optic rearview mirror assembly lacks an element covering the contoured portion.

These and other features, advantages, and objects of the present disclosure will be further understood and appreciated by those skilled in the art by reference to the following specification, claims, and appended drawings.

### BRIEF DESCRIPTION OF THE DRAWINGS

In the Drawings:

FIG. 1 is a front elevation view of an electro-optic rearview mirror assembly of the present disclosure, illustrating a rearview element mounted to a mounting assembly;

FIG. 2 is a side elevation view of the electro-optical rearview mirror assembly, illustrating the rearview element including a perimeter surface with a contoured portion that is exposed to an external environment;

FIG. 3 is an exploded front perspective view of the rearview element, illustrating, moving forward to rearward, a forward glass substrate, a forward polymer substrate, a forward electrochromic substrate, a seal, a rear electrochromic substrate, a rearward polymer substrate, and a rearward glass substrate, all of which form a portion of the contoured portion of the perimeter surface of the rearview element;

FIG. 4 is an exploded rear perspective view of the rearview element, illustrating the rearview element further including ink printing, a spectral filter ring, and a reflective layer;

FIG. 5 is a side view of the rearview element, illustrating the contoured portion of the perimeter surface present throughout an entirety of a side of the rearview element;

FIG. 6 is a magnified view of area VI of FIG. 5, illustrating adjacent layers contributing to the contoured portion of the perimeter surface being flush with each other (e.g., the forward glass substrate contributes a forward glass portion of the perimeter surface that is flush with a forward polymer portion of the perimeter surface contributed by the forward polymer substrate, and so on moving rearward);

FIG. 7 is a front elevation view of a cross-section of the rearview element taken through line VII-VII of FIG. 5, illustrating the seal extending along the perimeter edge to form a seal around an electrochromic medium;

FIG. 8 is a magnified view of area VIII of FIG. 7, illustrating the seal including a metallic strip, an outward insulative portion outward of the metallic strip forming part of the perimeter surface, and an inward insulative portion inward of the metallic strip;

FIG. 9 is a magnified view of area IX of FIG. 7, illustrating the seal further including a second metallic strip separated from the metallic strip by a gap;

FIG. 10 is a front elevational view of the rearview element;

FIG. 11 is an elevational view of a cross-section of the rearview element taken through line X-X of FIG. 10, illustrating a forward primary surface of the forward glass substrate exposed to the external environment and a rearward primary surface of the rearward glass substrate exposed to the external environment;

FIG. 12 is a magnified perspective view of area XII of FIG. 11, illustrating the rearward electrochromic substrate having an electrochromic recess where an edge thereof is recessed relative to an edge of the forward electrochromic recess;

FIG. 13 is a top plan view of the electro-optic rearview mirror assembly, illustrating the rearview element coupled to a rear housing of the mounting assembly;

FIG. 14 is a bottom plan view of the electro-optic rearview mirror assembly, illustrating the rear housing not extending beyond the two lateral sides of the rearview element and the contoured portion of the perimeter surface extending along an entirety of a bottom of the rearview element;

FIG. 15 is a rear elevation view of the electro-optic rearview mirror assembly, illustrating the contoured portion of the perimeter surface of the rearview element exposed to the external environment, and extending along an entirety, of the sides and the bottom of the rearview element and portions of a top of the rearview element;

FIG. 16 is side elevation view of a cross-section taken through line XVI-XVI of FIG. 1, illustrating a lip of the rearview housing extending above the electrochromic recess of the rearward electrochromic substrate but substantially flush with the perimeter surface provided by the forward electrochromic substrate;

FIG. 17 is an exploded perspective view of the electro-optic rearview mirror assembly, illustrating the mounting assembly including a double-sided adhesive foam tape adhering the rearview element (at the rearward primary surface of the rearward glass substrate) to a cover plate secured within the rear housing;

FIG. 18 is a side elevation view of a variation of the rearview element, illustrating a forward primary surface of the forward electrochromic substrate exposed to the external environment and being the forward-most surface of the rearview element, the rearview element lacking a forward polymer substrate and a forward glass substrate;

FIG. 19 is a front perspective exploded view of the rearview element of FIG. 18;

FIG. 20 is a front perspective exploded view of another variation of the rearview element, illustrating material that is electrically insulating and forming the outward insulative portion and the inward insulative portion of the seal disposed as a contiguous layer between the first metallic strip and the second metallic;

FIG. 21 is a magnified cross-sectional view similar to FIG. 12 but for the rearview element variation of FIG. 20, illustrating the electrically insulating material sandwiched between the first metallic strip and the second metallic strip; and

FIG. 22 is a schematic chart of a method of manufacturing the rearview element (including the variations), illustrating a seal formation step, a lamination step, and a contouring step.

### DETAILED DESCRIPTION

The present illustrated embodiments reside primarily in combinations of method steps and apparatus components related to a rearview element. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

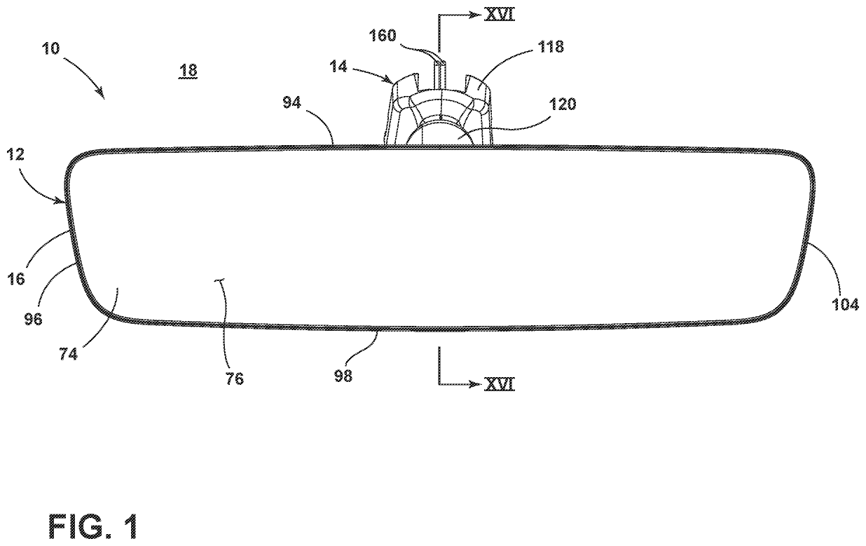

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

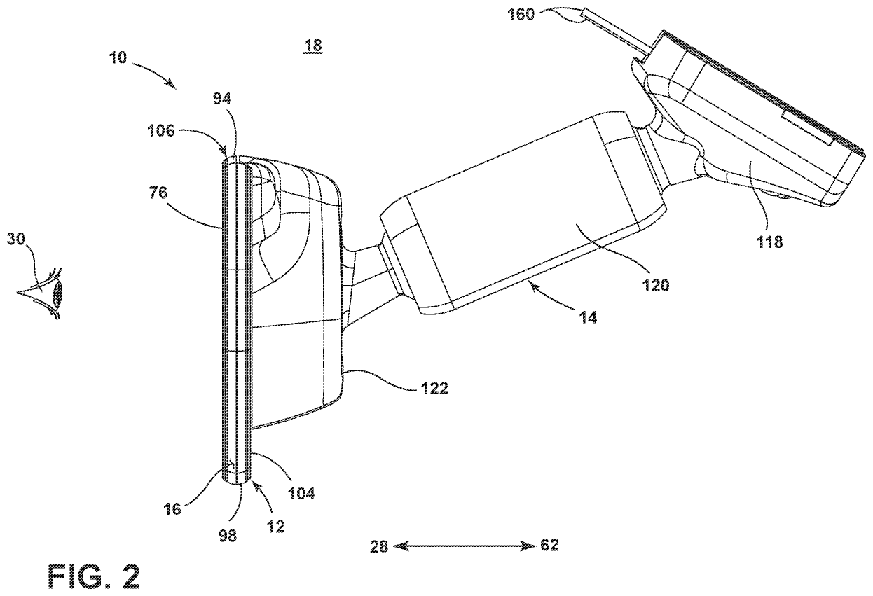

Referring to FIGS. 1 and 2, an electro-optic rearview mirror assembly 10 is herein disclosed. The electro-optic rearview mirror assembly 10 includes a rearview element 12 and a mounting assembly 14. The rearview element 12 is coupled to the mounting assembly 14. The rearview element 12 includes a perimeter surface 16. The perimeter surface 16 is exposed to an external environment 18. Both the rearview element 12 and the mounting assembly 14 are discussed in greater detail below.

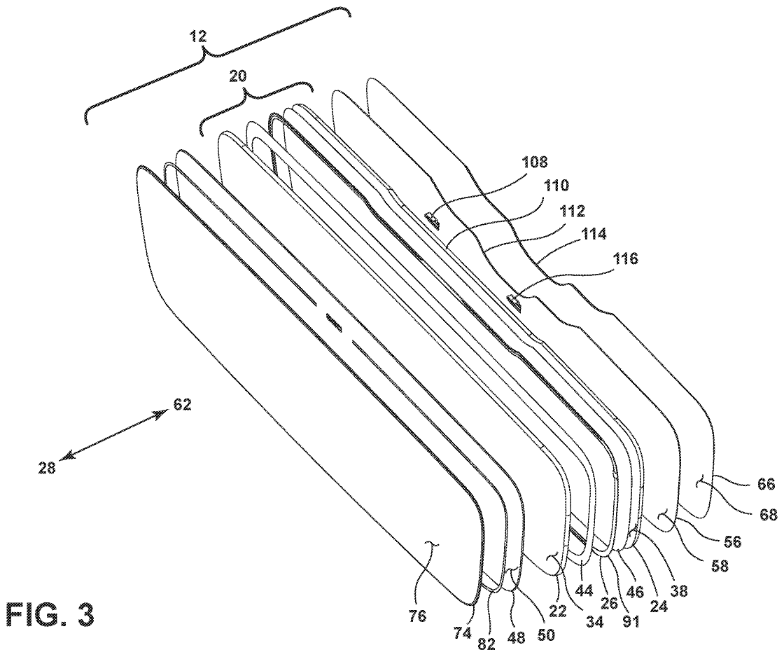

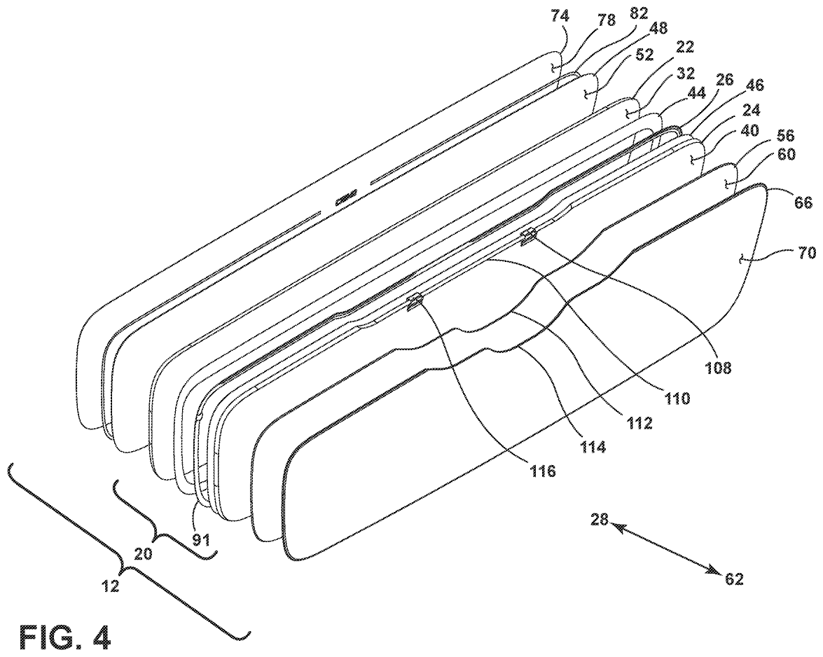

Referring now to FIGS. 3 and 4, the rearview element 12 includes an electrochromic element 20. The electrochromic element 20 includes a forward electrochromic substrate 22, a rearward electrochromic substrate 24, and a seal 26. “Forward” and “rearward” as used herein are relative to each other and denoted in the Drawings, with forward 28 being disposed closer to an eye 30 (see FIG. 2) of an intended viewer of the rearview element 12. The forward electrochromic substrate 22 includes a rearward primary surface 32 and a forward primary surface 34. The rearward primary surface 32 and the forward primary surface 34 both can be generally planar, parallel to each other, and face in opposite directions. The forward electrochromic substrate 22 is at least partially transparent to electromagnetic radiation of one or more wavelengths within the visible spectrum. For example, the forward electrochromic substrate 22 can exhibit a transmission of electromagnetic radiation of one or more wavelengths within the visible spectrum (or throughout an entirety of the visible spectrum) of ≥10%, ≥15%, ≥20%, ≥25%, ≥30%, 235%, >40%, ≥45%, ≥50%, ≥55%, ≥60%, ≥65%, ≥70%, ≥75%, ≥80%, ≥85%, or greater. The forward electrochromic substrate 22 can include a glass composition. However, other materials are envisioned.

The rearward electrochromic substrate 24 includes a forward primary surface 38 and a rearward primary surface 40. The forward primary surface 38 and the rearward primary surface 40 both can be generally planar, parallel to each other, and face in opposite directions. The forward primary surface 38 of the rearward electrochromic substrate 24 faces the rearward primary surface 32 of the forward electrochromic substrate 22. The rearward electrochromic substrate 24 can include a glass composition. However, other materials are envisioned.

The seal 26 is sandwiched between the forward electrochromic substrate 22 and the rearward electrochromic substrate 24. The seal 26 is discussed in greater detail below.

The electrochromic element 20 can further include a spectral filter ring 44. The spectral filter ring 44 is disposed forward 28 of the seal 26. For example, the spectral filter ring 44 can be disposed between the forward electrochromic substrate 22 and the rearward electrochromic substrate 24. The spectral filter ring 44 can be formed upon the rearward primary surface 32 of the forward electrochromic substrate 22. The spectral filter ring 44 can be disposed elsewhere within the rearview element 12 to be disposed between the eye 30 of the intended viewer and the seal 26, such as between the forward glass substrate 74 and the forward polymer substrate 48 instead of the ink printing 82. The spectral filter ring 44 can be disposed inward of the perimeter surface 16 and not exposed at the perimeter surface 16 (e.g., not visible from the external environment 18 except through other components of the rearview element 12). The spectral filter ring 44 can be made of chrome, although other materials are envisioned.

The electrochromic element 20 can further include a reflective layer 46. The reflective layer 46 is disposed between the forward electrochromic substrate 22 and the rearward electrochromic substrate 24. The reflective layer 46 is disposed rearward of the seal 26. For example, the reflective layer 46 can be formed upon the forward primary surface 38 of the rearward electrochromic substrate 24. The reflective layer 46 can entirely cover the forward primary surface 38 of the rearward electrochromic substrate 24.

The rearview element 12 can further include a forward polymer substrate 48. The forward polymer substrate 48 includes a forward primary surface 50 and a rearward primary surface 52. The forward primary surface 50 and the rearward primary surface 52 both can be planar, parallel to each other, and face in opposite directions. The forward polymer substrate 48 is disposed forward 28 of the forward electrochromic substrate 22. The forward polymer substrate 48, particularly the rearward primary surface 52 thereof, contacts and at least partially covers the forward primary surface 34 of the forward electrochromic substrate 22. The rearward primary surface 52 of the forward polymer substrate 48 can be laminated to the forward primary surface 34 of the forward electrochromic substrate 22. The forward polymer substrate 48 has a polymer composition, such as polyvinyl butyral, although other materials are envisioned. The forward polymer substrate 48 is at least partially transparent to electromagnetic radiation of one or more wavelengths within the visible spectrum. For example, the forward polymer substrate 48 can exhibit a transmission of electromagnetic radiation of one or more wavelengths within the visible spectrum (or throughout an entirety of the visible spectrum) of ≥10%, ≥15%, ≥20%, ≥25%, ≥30%, ≥35%, >40%, ≥45%, ≥50%, ≥55%, ≥60%, ≥65%, ≥70%, ≥75%, ≥80%, ≥85%, or greater. The forward polymer substrate 48 includes a thickness 49. The thickness 49 is the shortest straight-line distance between forward primary surface 50 and the rearward primary surface 52. In embodiments, the thickness 49 is less than or equal to 0.45 mm (e.g., 0.39 mm).

The rearview element 12 can further include a rearward polymer substrate 56. The rearward polymer substrate 56 includes a forward primary surface 58 and a rearward primary surface 60. The forward primary surface 58 and the rearward primary surface 60 both can be planar, parallel to each other, and face in opposite directions. The rearward polymer substrate 56 is disposed rearward 62 of the rearward electrochromic substrate 24. The rearward polymer substrate 56 contacts and at least partially covers the rearward primary surface 40 of the rearward electrochromic substrate 24. The forward primary surface 58 of the rearward polymer substrate 56 can be laminated to the rearward primary surface 40 of the rearward electrochromic substrate 24. The rearward polymer substrate 56 can be substantially opaque to electromagnetic radiation throughout an entirety of the visible spectrum. For example, the rearward polymer substrate 56 can exhibit a transmission of electromagnetic radiation throughout an entirety of the visible spectrum of ≤50%, ≤45%, ≤40%, ≤35%, ≤30, ≤25%, ≤20%, ≤15%, ≤10%, or less. The rearward polymer substrate 56 can exhibit a black color. The rearward polymer substrate 56 being substantially opaque reduces light transmission therethrough that could interfere with the performance of the electrochromic element 20. The rearward polymer substrate 56 further includes a thickness 57. The thickness 57 is the shortest straight-line distance between forward primary surface 58 and the rearward primary surface 60. In embodiments, the thickness 57 is less than or equal to 0.45 mm (e.g., 0.39 mm). The rearward polymer substrate 56 is made of a polymer such as polyvinyl butyral, although other materials are envisioned.

The rearview element 12 can further include a rearward glass substrate 66. The rearward glass substrate 66 includes a forward primary surface 68 and a rearward primary surface 70. The forward primary surface 68 and the rearward primary surface 70 each can be planar, parallel to each other, and face in opposite directions. The rearward glass substrate 66 is disposed rearward 62 of the rearward primary surface 70. The rearward glass substrate 66 contacts and at least partially covers the rearward primary surface 60 of the rearward polymer substrate 56. The forward primary surface 68 of the rearward glass substrate 66 faces, and can be laminated, to the rearward primary surface 60 of the rearward polymer substrate 56. The rearward glass substrate 66 further includes a thickness 67. The thickness 67 is the shortest straight-line distance between the forward primary surface 68 and the rearward primary surface 70. In embodiments, the thickness 67 is less than or equal to 0.75 mm (e.g., 0.50 mm). The rearward glass substrate 66 is made of glass, such as soda lime glass, borosilicate glass, among other options.

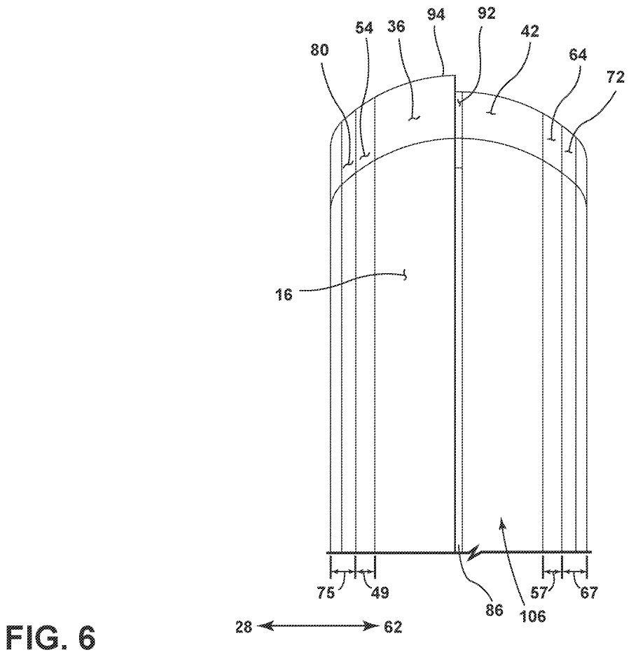

The rearview element 12 can further include a forward glass substrate 74. The forward glass substrate 74 includes a forward primary surface 76 and a rearward primary surface 78. The forward primary surface 76 and the rearward primary surface 78 both can be planar, parallel to each other, and face in opposite directions. The forward glass substrate 74 is disposed forward 28 of the forward polymer substrate 48. The forward glass substrate 74 contacts and at least partially covers the forward primary surface 50 of the forward polymer substrate 48. The rearward primary surface 78 of the forward glass substrate 74 can be laminated to the forward primary surface 50 of the forward polymer substrate 48. The forward glass substrate 74 has a glass composition, which can be soda lime glass, borosilicate glass, among other options. The forward glass substrate 74 is at least partially transparent to electromagnetic radiation of one or more wavelengths within the visible spectrum. For example, the forward glass substrate 74 can exhibit a transmission of electromagnetic radiation of one or more wavelengths within the visible spectrum (or throughout an entirety of the visible spectrum) of ≥10%, ≥15%, ≥20%, ≥25%, ≥30%, ≥35%, >40%, ≥45%, ≥50%, ≥55%, ≥60%, ≥65%, ≥70%, ≥75%, ≥80%, ≥85%, or greater. The first glass substrate 74 includes a thickness 75 (see FIG. 6), which is the shortest straight-line distance between the forward primary surface 50 and the rearward primary surface 78. In embodiments, the thickness 75 of the first glass substrate 74 is less than or equal to 0.75 mm (e.g., 0.50 mm).

In order then of relative spatial orientation from the eye 30 of an intended viewer, the rearview element 12 includes the forward glass substrate 74, the forward polymer substrate 48, the electrochromic element 20, the rearward polymer substrate 56, and the rearward glass substrate 66. The forward glass substrate 74 is disposed closest to the eye 14 of the operator of the vehicle, as the intended viewer.

The rearview element 12 can further include ink printing 82. The ink printing 82 is disposed between the forward glass substrate 74 and the forward polymer substrate 48. For example, the ink printing 82 can be printed on the rearward primary surface 78 of the forward glass substrate 74 before the forward glass substrate 74 and the forward polymer substrate 48 are laminated together. The ink printing 82 can have an ink composition. The ink printing 82 can provide decoration or branding visible to the eye 30 through the forward glass substrate 74. The ink printing 82 is separated from the perimeter surface 16 of the rearview element 12 (e.g., disposed inward from the perimeter surface 16).

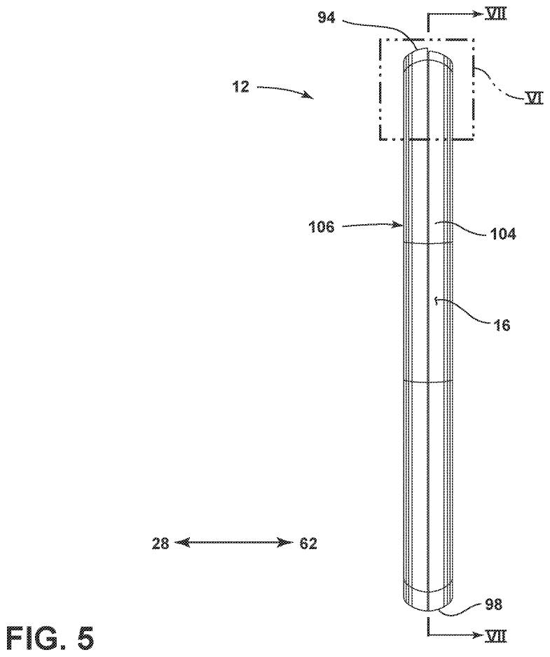

Referring now to FIGS. 5 and 6, the forward electrochromic substrate 22 forms a forward electrochromic portion 36 of the perimeter surface 16. The rearward electrochromic substrate 24 forms a rearward electrochromic portion 42 of the perimeter surface 16. The forward polymer substrate 48 forms a forward polymer portion 54 of the perimeter surface 16. The rearward polymer substrate 56 forms a rearward polymer portion 64 of the perimeter surface 16. The rearward glass substrate 66 forms at least a rearward glass portion 72 of the perimeter surface 16. The forward glass substrate 74 forms a forward glass portion 80 of the perimeter surface 16.

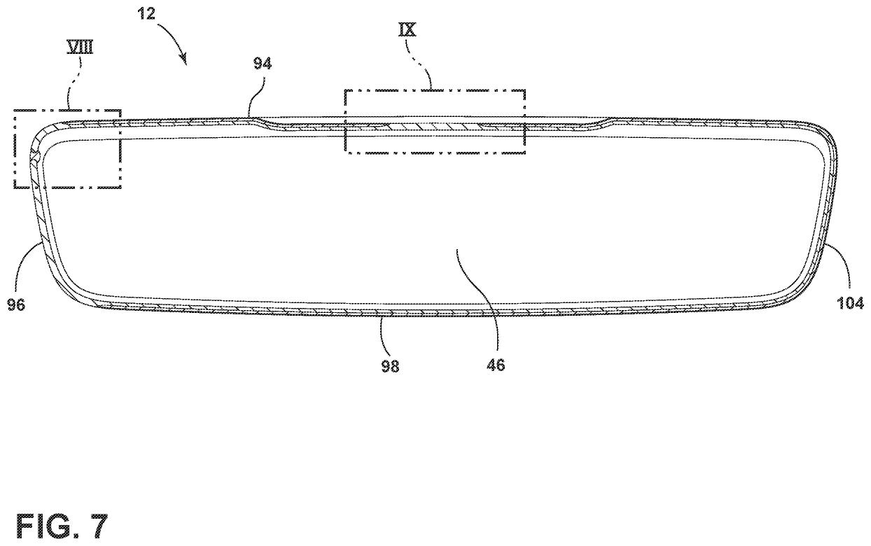

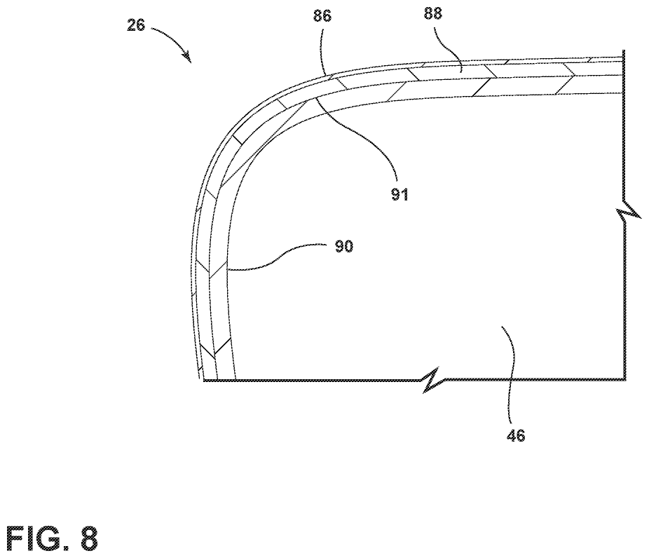

Referring to FIGS. 7 and 8, in embodiments, the seal 26 includes an outward insulative portion 86, a metallic strip 88, and an inward insulative portion 90. The outward insulative portion 86 and the inward insulative portion 90 are formed of a material 91 that is substantially electrically insulative and substantially nontransparent. Black epoxy resin is an example of such a material. The outward insulative portion 86 forms at least a seal portion 92 (see FIG. 6) of the perimeter surface 16. The metallic strip 88 is disposed inward of the outward insulative portion 86 and is not exposed at the perimeter surface 16. The inward insulative portion 90 is disposed inward from the metallic strip 88. The metallic strip 88 can extend along, but separated from, the seal portion 92 of the perimeter surface 16 at a top 94 of the rearview element 12, a side 96 of the rearview element 12, and a bottom 98 of the rearview element 12.

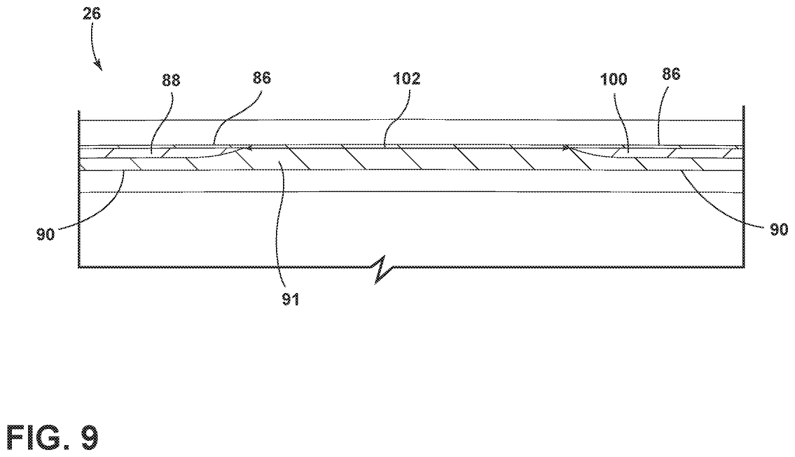

Referring to FIG. 9, the seal 26 can further include a second metallic strip 100. The second metallic strip 100 is inward from the outward insulative portion 86. The second metallic strip 100 is outward of the inward insulative portion 90. The second metallic strip 100 is separated from the metallic strip 88 by a gap 102. The gap 102 separating the metallic strip 88 and the second metallic strip 100 allows capacitance to be generated. The second metallic strip 100 is not exposed at the perimeter surface 16. The second metallic strip 100 extends along the seal portion 92 of the perimeter surface 16, such as at the top 94 of the rearview element 12 and along another side 104 of the rearview element 12 (further from the side 96 than the metallic strip 88).

Referring back to FIGS. 5 and 6, the perimeter surface 16 of the rearview element 12 has a contoured portion 106. The perimeter surface 16, in the embodiment thus far illustrated, extends between the forward primary surface 76 of the forward glass substrate 74 and the rearward primary surface 70 of the rearward glass substrate 66. At the contoured portion 106 of the perimeter surface 16, the forward electrochromic portion 36 of the perimeter surface 16 is substantially flush with the seal portion 92 of the perimeter surface 16. In turn, at the contoured portion 106, the seal portion 92 of the perimeter surface 16 is substantially flush with the rearward electrochromic portion 42. Further, at the contoured portion 106, the forward polymer portion 54 is substantially flush with the forward electrochromic portion 36, and the rearward polymer portion 64 is substantially flush with the rearward electrochromic portion 42. Likewise, at the contoured portion 106, the rearward glass portion 72 is substantially flush with the rearward polymer portion 64, and the forward glass portion 80 is substantially flush with the forward polymer portion 54. Considered rearward 62 from the forward primary surface 76 of the forward glass substrate 74 to the rearward primary surface 70 of the rearward glass substrate 66, each component forming part of the perimeter surface 16 at the contoured portion 106 is flush with the next rearward 62 component. The contoured portion 106 can be formed by grinding or some other material removal process. The contoured portion 106, moving forward 28 to rearward 62 along the perimeter surface 16, can be curved or sloped without a planar step. The forward glass portion 80 can be beveled inward from the forward polymer portion 54. The forward polymer portion 54 can be beveled inward from the forward electrochromic portion 36. The rearward polymer portion 64 can be beveled inward from the rearward electrochromic portion 42. The rearward glass portion 72 can be beveled inward from the rearward polymer portion 64.

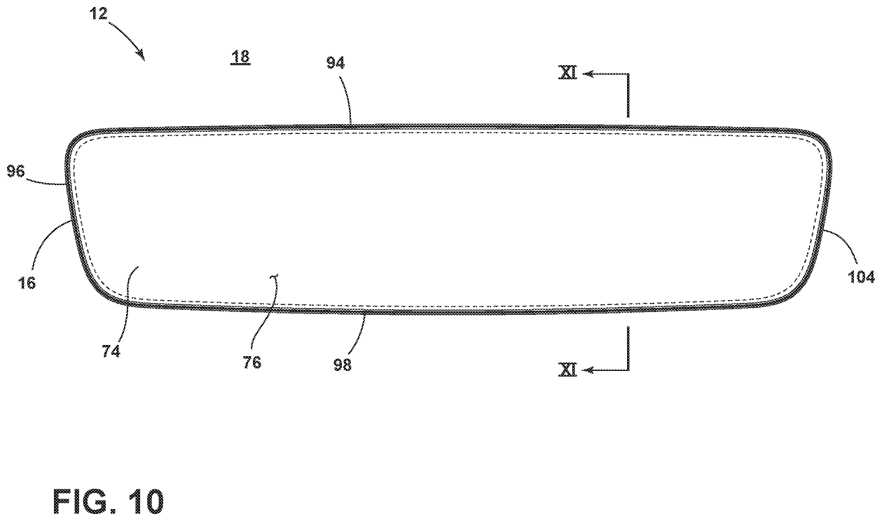

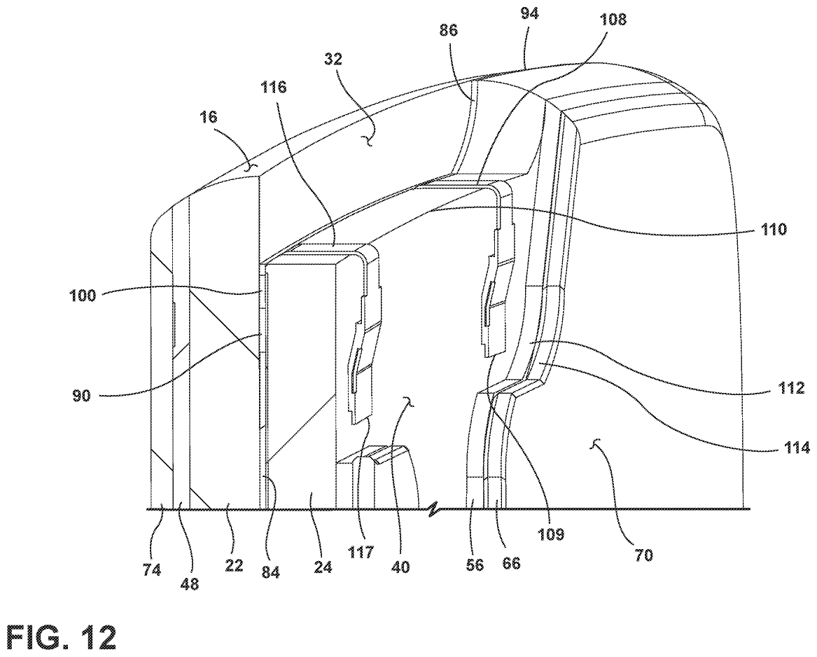

Referring additionally to FIGS. 10-12, the electrochromic element 20 further includes an electrochromic medium 84. The electrochromic medium 84 is sandwiched between the forward electrochromic substrate 22 and the rearward electrochromic substrate 24. The electrochromic medium 84 is disposed inward of the perimeter surface 16. The seal 26 separates the electrochromic substrate from the perimeter surface 16. The seal 26 surrounds the electrochromic medium 84. The seal 26 seals the electrochromic medium 84 between the forward electrochromic substrate 22 and the rearward electrochromic substrate 24. The reflective layer 46 is disposed rearward 62 of the electrochromic medium 84.

The metallic strip 88 is electrically conductive and is in electrical communication with the electrochromic medium 84. The second metallic strip 100 is in electrical communication with the electrochromic medium 84.

The electrochromic element 20 further includes a clip 108. The clip 108 is electrically conductive. The clip 108 has a first end 107 and a second end 109. The clip 108 is in contact with the metallic strip 88 of the seal 26, such as at or proximate the first end 107. The rearward electrochromic substrate 24 includes an electrochromic recess 110. At the electrochromic recess 110, the perimeter surface 16 provided by the rearward electrochromic substrate 24 is disposed inward from the perimeter surface 16 provided by the forward electrochromic substrate 22. From the first end 107 and where the clip 108 contacts the metallic strip 88, the clip 108 extends along the forward primary surface 38 of the rearward electrochromic substrate 24, over the perimeter surface 16 provided by the rearward electrochromic substrate 24 at the electrochromic recess 110, and along the rearward primary surface 40 of the rearward electrochromic substrate 24 to terminate at the second end 109. Similar to the rearward electrochromic substrate 24, the rearward polymer substrate 56 includes a polymer recess 112 where the perimeter surface 16 provided by the rearward polymer substrate 56 is inset relative to the electrochromic recess 110. The polymer recess 112 accommodates the presence of the clip 108. The rearward glass substrate 66 can include a glass recess 114 where the perimeter surface 16 provided by the rearward glass substrate 66 is inset relative to the electrochromic recess 110 and aligned with the polymer recess 112.

The electrochromic element 20 can further include a second clip 116. The second clip 116 is electrically conductive. The second clip 116 has a first end 115 and a second end 117. The second clip 116 is in contact with the second metallic strip 100 of the seal 26, such as at or proximate the first end 115. From where the first end 115 and where the second clip 116 contacts the second metallic strip 100, the second clip 116 extends along the forward primary surface 38 of the rearward electrochromic substrate 24, over the perimeter surface 16 provided by the rearward electrochromic substrate 24 at the electrochromic recess 110, and along the rearward primary surface 40 of the rearward electrochromic substrate 24 to terminate at the second end 117. The polymer recess 112 of the rearward polymer substrate 56 and the glass recess 114 of the rearward glass substrate 66 accommodate the presence of the second clip 116. With the clip 108 and the second clip 116, the electrochromic element 20 can be electrically controlled to manipulate the transmission through portions of the electrochromic element 20 and the reflectivity of the electro-optic rearview mirror assembly 10 as a whole.

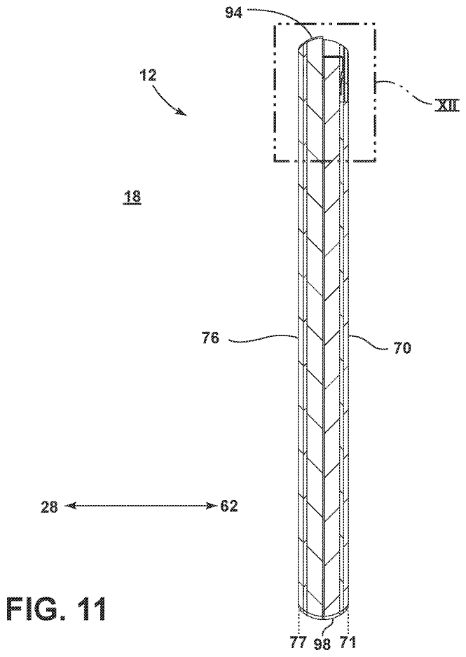

The forward primary surface 76 of the forward glass substrate 74 forms a first plane 77 (see FIG. 11). The rearward primary surface 70 of the rearward glass substrate 66 forms a second plane 71. The first plane 77 and the second plane 71 are generally parallel to each other. The clip 108 and the second clip 116 are disposed between the first plane 77 and the second plane 71.

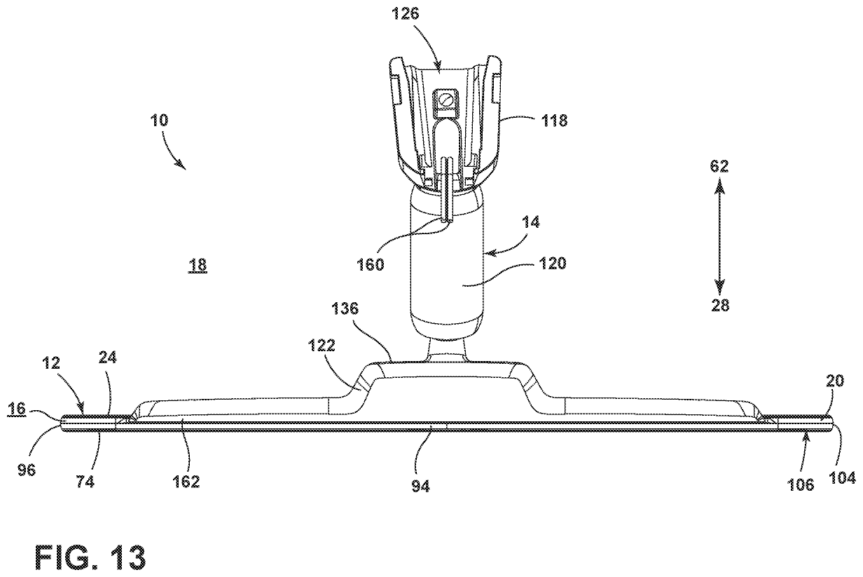

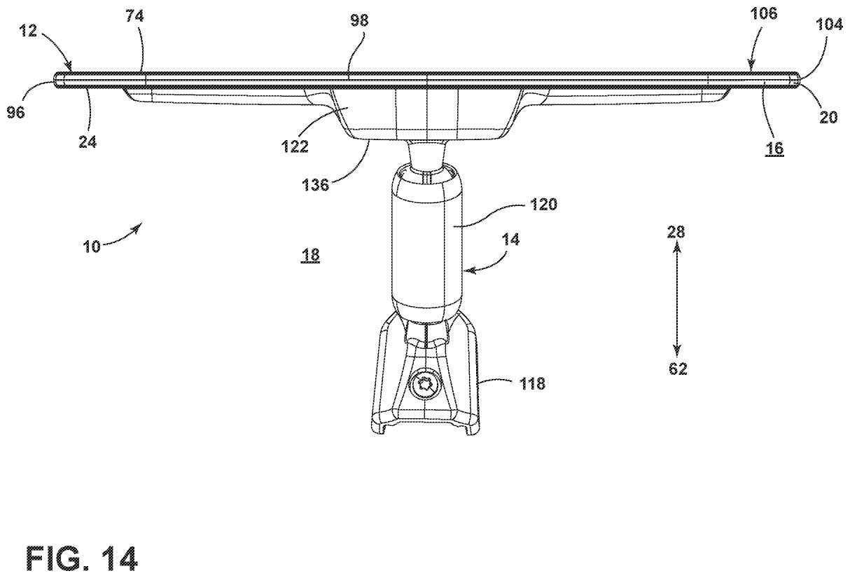

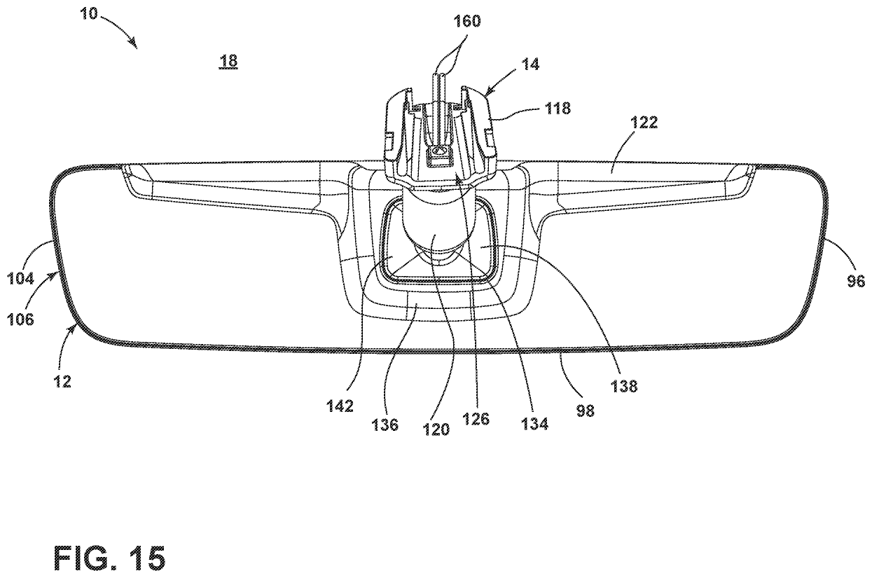

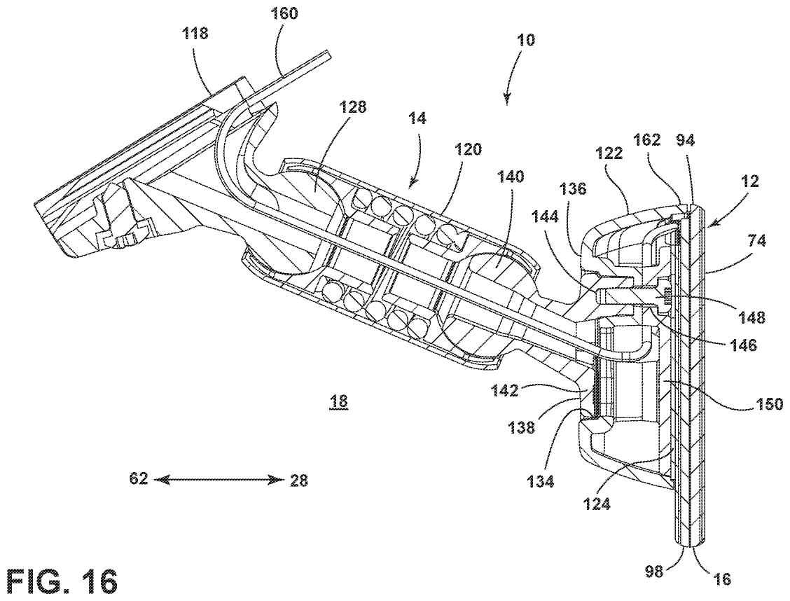

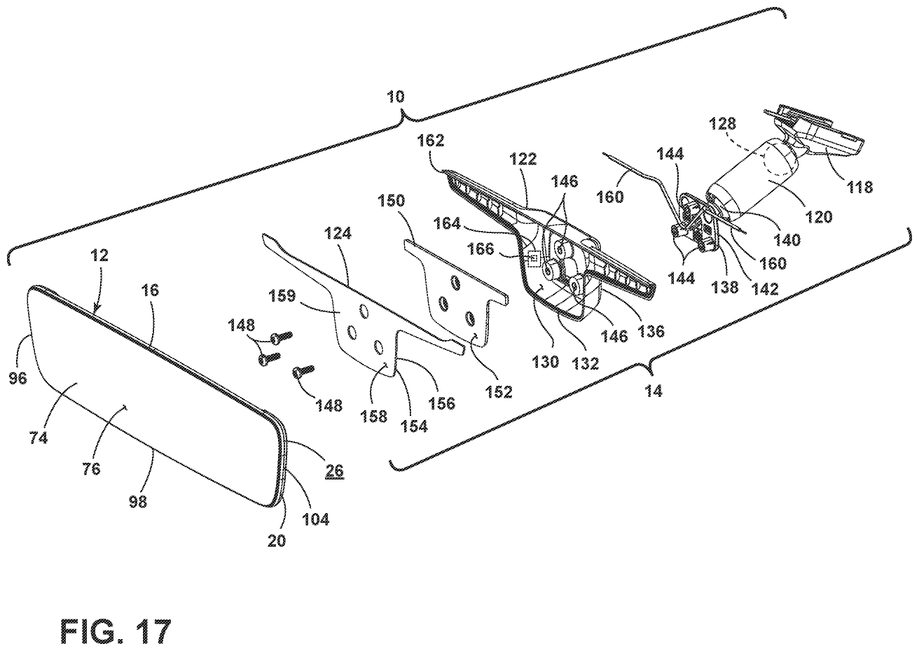

Referring additionally to FIGS. 13-17, as mentioned, the electro-optic rearview mirror assembly 10 further includes the mounting assembly 14. As in the illustrated embodiment, the mounting assembly 14 can include a base 118, a mount barrel 120, a rear housing 122, and double-sided adhesive foam tape 124. The base 118 is configured to be secured to the windshield (not illustrated) or overhead space of the vehicle. For example, the base 118 can include a channel 126 (see FIG. 15) to receive a button (not illustrated) adhered to the windshield. The mount barrel 120 is coupled to the base 118. For example, the base 118 can include a mount ball 128 (see FIG. 16), and the mount barrel 120 can engage (e.g., partially encircle) the mount ball 128. The rear housing 122 is coupled to the mount barrel 120. For example, the rear housing 122 can include a cavity 130 (see FIG. 17) accessible from one side 132 and a recess 134 (FIG. 15) accessible from another side 136. A housing mount 138 includes a device ball 140 (FIG. 16) that the mount barrel 120 engages (e.g., partially encircles). The housing mount 138 further includes a platform 142 from which the device ball 140 extends. The platform 142 includes apertures 144. The housing mount 138 sits within the recess 134 of the rear housing 122. The rear housing 122 includes apertures 146 open at both sides 132, 134 that are aligned with the apertures 144 of the platform 142. Fasteners 148 extend through the aligned apertures 144, 146 of the platform 142 and the rear housing 122 to fasten them together. A cover plate 150 is additionally fastened, with the same fasteners 148, at the side 96 of the rear housing 122 to partially cover the cavity 130 and provide a relatively planar surface 152 (FIG. 17). The double-sided adhesive foam tape 124 is coupled to the rear housing 122 and the rearview element 12. For example, adhesive providing a first primary surface 154 at one side 156 of the double-sided adhesive foam tape 124 adheres to the relatively planar surface 152 of the cover plate 150.

The rearview element 12 is coupled to the mounting assembly 14. More particularly, adhesive providing a second primary surface 158 at another side 159 of the double-sided adhesive foam tape 124 adheres to the rearward primary surface 70 of the rearward glass substrate 66 of the rearview element 12. The mounting assembly 14 is coupled to the rearview element 12 solely via adhesive and one or more electrical connections. The one or more electrical connections are made via the clip 108 and the second clip 116 of the rearview element 12. The mounting assembly 14 can guide wires 160 that are electrically connected to the clip 108 and the second clip 116.

The contoured portion 106 of the perimeter surface 16, which the forward glass portion 80, the forward polymer portion 54, the forward electrochromic portion 36, the seal portion 92, the rearward electrochromic portion 42, the rearward polymer portion 64, and the rearward glass portion 72 collectively form, is exposed to the external environment 18. The mounting assembly 14 lacks an element covering the contoured portion 106. The mounting assembly 14 leaves an entirety of the perimeter surface 16 of the rearview element 12 provided by the forward polymer substrate 48, the forward glass substrate 74, and forward electrochromic substrate 22 (e.g., the forward polymer portion 54, the forward glass portion 80, and the forward electrochromic portion 36, respectively) exposed to the external environment 18. Similarly, the mounting assembly 14 leaves at least the contoured portion 106 of the perimeter surface 16 provided by the seal 26, the rearward electrochromic substrate 24, the rearward polymer substrate 56, and the rearward glass substrate 66 (e.g., the seal portion 92, the rearward electrochromic portion 42, the rearward polymer portion 64, and the rearward glass portion 92, respectively) exposed to the external environment 18. As mentioned, the rearview element 12 includes the top 94, the bottom 98, and the sides 132, 134. The contoured portion 106 of the perimeter surface 16 of the rearview element 12 at the top 94, the bottom 98, and the sides 132, 134 is entirely exposed to the external environment 18 without any bezel or housing covering the contoured portion 106.

Further, the electrochromic recess 110, the polymer recess 112, and the glass recess 114 permit a lip 162 of the rear housing 122 to extend over the perimeter surface 16 provided by the rearward electrochromic substrate 24, the rearward polymer substrate 56, and the rearward glass substrate 66 and still be flush with, or recessed relative to, the perimeter surface 16 provided by the forward electrochromic portion 36, the forward polymer portion 54, and the forward glass portion 80. In embodiments, aside from the electrochromic recess 110, the polymer recess 112, and the glass recess 114, the entirety of the perimeter surface 16 is the contoured portion 106 thereof. Moreover, the mounting assembly 14, particularly the rear housing 122, covers electrical connections to the electrochromic element 20 but leaves more than half of the area of the rearward primary surface 70 of the rearward glass substrate 66 exposed to the external environment 18.

The mounting assembly 14 can further include a printed circuit board 164. The printed circuit board 164 can include a microcontroller 166 that is in communication with a forward mounted light sensor (not illustrated) and a rearward mounted light sensor (not illustrated), as well as the electrochromic element 20. The microcontroller 166 can manipulate the electrochromic element 20 as a function of output received from the forward mounted light sensor and the rearward mounted light sensor.

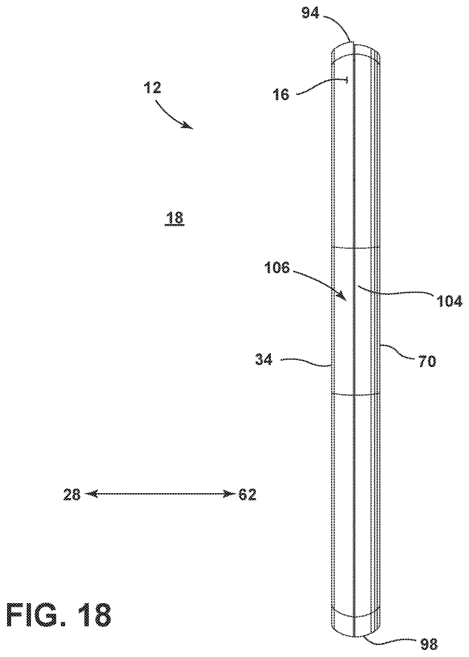

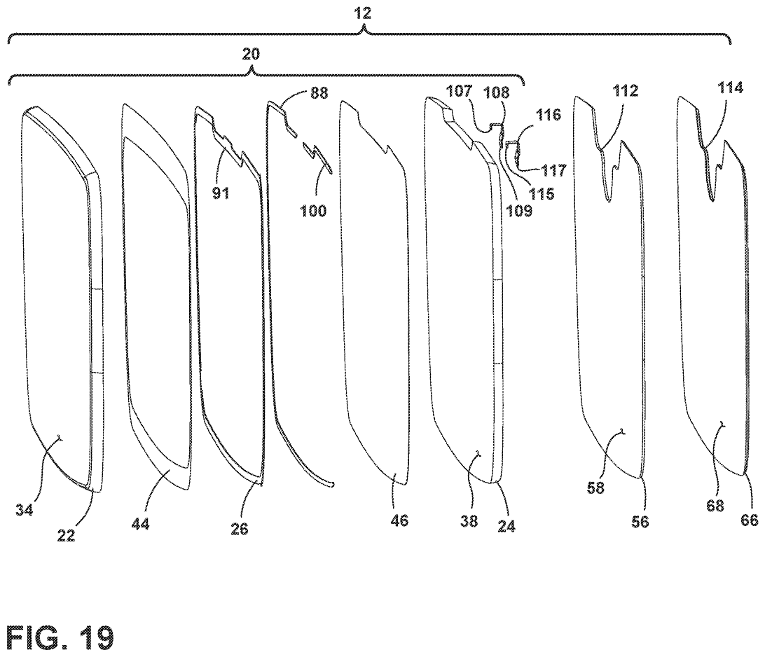

As mentioned, in embodiments such as that illustrated thus far, the rearview element 12 can include the forward glass substrate 74 and the forward polymer substrate 48. However, referring now to FIGS. 18 and 19, in other embodiments, the rearview element 12 does not include the forward glass substrate 74, the forward polymer substrate 48, or the ink printing 82 therebetween. In such embodiments, the forward primary surface 34 of the forward electrochromic substrate 22 is exposed to the external environment 18. The rearview element 12 is otherwise the same as the rearview element 12.

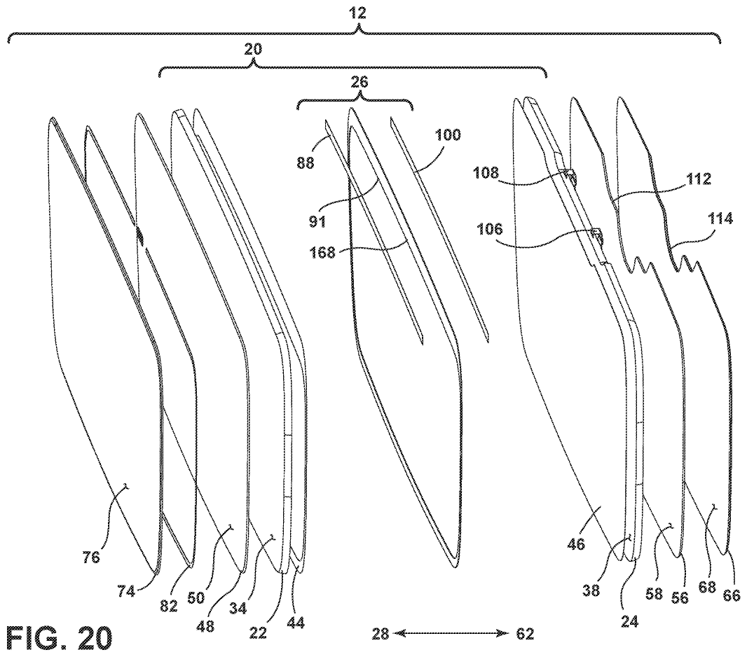

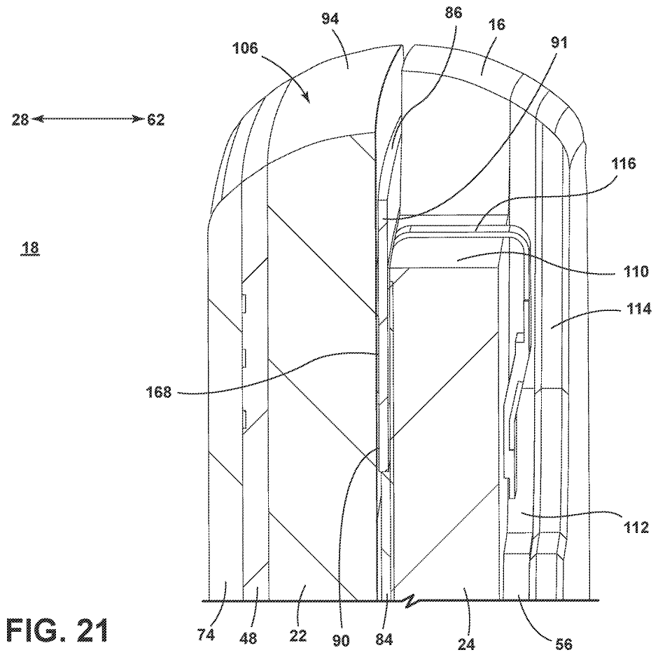

In a variation of the seal 26, referring now to FIGS. 20 and 21, the material 91 that is substantially electrically insulative and substantially nontransparent forms both the outward insulative portion 86 of the seal 26 and, contiguously, the inward insulative portion 90 of the seal 26. The material 91, in a contiguous layer 168, forms both the outward insulative portion 86 of the seal 26 and the inward insulative portion 90 of the seal 26. The metallic strip 88, which is in electrical communication with the clip 108, is sandwiched between the material 91 and one of the forward electrochromic substrate 22 and the rearward electrochromic substrate 24.

The seal 26, in the variation, further includes the second metallic strip 100 aligned with the metallic strip 88. The second metallic strip 100 is in electrical communication with the second clip 116. The second metallic strip 100 is sandwiched between the material 91 that is substantially electrically insulative and substantially transparent and the other of the forward electrochromic substrate 22 and the rearward electrochromic substrate 24. The material 91 separates the metallic strip 88 from the second metallic strip 100. If the metallic strip 88 is disposed between the forward electrochromic substrate 22 and the material 91, then the second metallic strip 100 is disposed between the material 91 and the rearward electrochromic substrate 24. However, if the metallic strip 88 is disposed between the material 91 and the rearward electrochromic substrate 24, then the second metallic strip 100 is disposed between the forward electrochromic substrate 22 and the material 91.

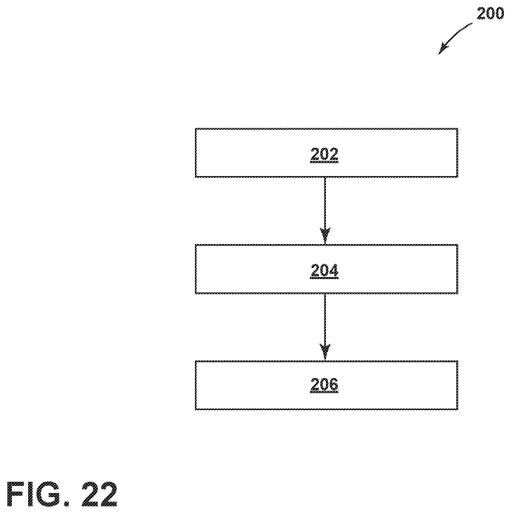

Referring now to FIG. 22, a method 200 of manufacturing the various embodiments of the rearview element 12 is herein disclosed. The method 200 includes a laminating step 204, a contouring step 206, and optionally a seal formation step 202 that would occur before the laminating step 204 and the contouring step 206. If performed, the seal formation step 202 includes depositing the material 91 that is substantially electrically insulative and substantially nontransparent upon either of what will become the forward electrochromic substrate 22 or the rearward electrochromic substrate 24, such as upon the reflective layer 46 already disposed upon the rearward electrochromic substrate 24. The material 91 can be patterned, such as with a mask, so as to form what will become the outward insulative portion 86 and the inward insulative portion 90. The metallic strip 88 can then be deposited, again with a mask, upon the reflective layer 46 within an interstitial area between the material 91 forming what will become the outward insulative portion 86 and the inward insulative portion 90. Likewise, with the second metallic strip 100. In other instances, the material 91 can be deposited without an interstitial area and the metallic strip 88 and the second metallic strip 100 can be deposited on the material 91 using a mask so as to leave what will become the outward insulative portion 86 and the inward insulative portion 90 uncovered by either the metallic strip 88 or the second metallic strip 100. In yet another variation, the metallic strip 88 can be deposited upon the reflective layer 46, the material 91 can then be deposited over the metallic strip 88, and then the second metallic strip 100 can be deposited over the material 91. The material 91 is deposited in excess over metallic strip so as to envelope the metallic strip 88 along with the reflective layer 46. These are just examples of how to perform the seal formation step 202, and other procedures are envisioned.

The laminating step 204 includes laminating, in order of relative spatial orientation, the forward electrochromic substrate 22 (with the spectral filter ring 44 thereupon, if included) and the rearward electrochromic substrate 24 (with the seal 26 thereupon) together with the electrochromic medium 84 therebetween and part of the clip 108 and the second clip 116 therebetween to form the electrochromic element 20. Simultaneously or subsequently, the rearward polymer substrate 56 and the rearward glass substrate 66 can be laminated (at the same time or separately) onto the rearward primary surface 40 of the rearward electrochromic substrate 24. Simultaneously or subsequently, the forward polymer substrate 48 and the rearward substrate can be laminated (at the same time or separately) onto the forward primary surface 34 of the forward electrochromic substrate 22. The ink printing 82 may have already been printed upon the rearward primary surface 32 of the forward glass substrate 74 or the forward primary surface 50 of the forward polymer substrate 48.

The contouring step 206 includes grinding the perimeter surface 16 provided by the forward glass substrate 74, the forward polymer substrate 48, the forward electrochromic substrate 22, seal 26, the rearward electrochromic substrate 24, the rearward polymer substrate 56, and the rearward glass substrate 66 until the contoured portion 106 as desired is formed, for example to achieve a beveled shape.

The rearview element 12 and the method 200 of the present disclosure address the problem, and others, described in the Background, in a variety of ways. Among them, the perimeter surface 16 of the rearview element 12 is entirely or predominately exposed to the external environment 18. For example, the contoured portion 106 of the perimeter surface 16 can be entirely exposed to the external environment 18. More particularly, the forward glass portion 80, the forward polymer portion 54, and the forward electrochromic portion 36 are entirely exposed to the external environment 18. Likewise, at the sides 132, 134 and the bottom 98, the seal portion 92, the rearward electrochromic portion 42, the rearward polymer portion 64, and the rearward glass portion 72 are entirely exposed to the external environment. Portions of the perimeter surface 16 provided by the rearward electrochromic element 20, the rearward polymer substrate 56, and the rearward glass substrate 66 that might be covered by the rear housing 122 are recessed relative to the forward electrochromic substrate 22 and therefore blocked from the view of the eye 30. That is all highly aesthetically pleasing. In addition, the mounting assembly 14 is relatively minimalistic-the rearview element 12 is adhered thereto and the rear housing 122 of the mounting assembly 14 covers less than half of the area of the rearward primary surface 70 of the rearward glass substrate 66. That is also more aesthetically pleasing and is more optimal to manufacture in terms of cost and time. Further, the material 91 that is substantially electrically insulative and substantially nontransparent provides the outward insulative portion 86 that is the seal portion 92 of the perimeter surface 16 and masks the metallic strip 88 from view of the eye 30. The perimeter surface 16 can be contoured to form the contoured portion 106 without bringing the metallic strip 88 to the perimeter surface 16. Exposing the metallic strip 88 to the external environment 18 could decrease performance of the electrochromic element 20. However, the presence of the material 91 between the external environment 18 and the metallic strip 88 avoids that. Enough of the material 91 is disposed outward of the metallic strip 88 before the contouring step 206 so that the outward insulative portion 86 remains after the contouring step 206.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to a first aspect of the present disclosure, an electro-optic rearview mirror assembly comprises: a rearview element comprising: (a) a perimeter surface; (b) a forward electrochromic substrate having a forward primary surface and a rearward primary surface, the forward electrochromic substrate forming a forward electrochromic portion of the perimeter surface; (c) a rearward electrochromic substrate having a forward primary surface and a rearward primary surface, the rearward electrochromic substrate forming a rearward electrochromic portion of the perimeter surface; (d) an electrochromic medium sandwiched between the forward electrochromic substrate and the rearward electrochromic substrate; (e) a forward polymer substrate disposed forward of the forward electrochromic substrate, the forward polymer substrate forming a forward polymer portion of the perimeter surface, the forward polymer substrate contacting and at least partially covering the forward primary surface of the forward electrochromic substrate, the forward polymer substrate comprising a forward primary surface and a rearward primary surface facing away from forward primary surface of the forward polymer substrate and facing the forward primary surface of the forward electrochromic substrate; (f) a forward glass substrate disposed forward of the forward polymer substrate, the forward glass substrate forming a forward glass portion of the perimeter surface, the forward glass substrate contacting and at least partially covering the forward primary surface of the forward polymer substrate, the forward glass substrate comprising a forward primary surface and a rearward primary surface facing away from the forward primary surface of the forward glass substrate and facing the forward primary surface of the forward polymer substrate layer; (g) a rearward polymer substrate disposed rearward of the rearward electrochromic substrate, the rearward polymer substrate forming a rearward polymer portion of the perimeter surface, the rearward polymer substrate contacting and at least partially covering the rearward primary surface of the rearward electrochromic substrate, the rearward polymer substrate comprising a forward primary surface facing the rearward primary surface of the rearward electrochromic substrate and a rearward primary surface facing away from the forward primary surface of the rearward polymer substrate; and (h) a rearward glass substrate disposed rearward of the rearward polymer substrate, the rearward glass substrate forming a rearward glass portion of the perimeter surface, the rearward glass substrate contacting and at least partially covering the rearward primary surface of the rearward polymer substrate, the rearward glass substrate comprising a forward primary surface facing the rearward primary surface of the rearward polymer substrate and a rearward primary surface facing away from the forward primary surface of the rearward glass substrate; wherein, the perimeter surface has a contoured portion where (i) the forward polymer portion is substantially flush with the forward electrochromic portion, (ii) the forward glass portion is substantially flush with the forward polymer portion, (iii) the rearward polymer portion is substantially flush with the rearward electrochromic portion, and (iv) the rearward glass portion is substantially flush with the rearward polymer portion, and wherein, the contoured portion of the perimeter surface is exposed to an external environment and the electro-optic rearview mirror assembly lacks an element covering the contoured portion.

According to a second aspect of the present disclosure, the electro-optic rearview mirror assembly of the first aspect is presented, wherein (i) the forward glass portion is beveled inward of the forward polymer portion, (ii) the forward polymer portion is beveled inward of the forward electrochromic portion, (iii) the rearward polymer portion is beveled inward of the rearward electrochromic portion, and (iv) the rearward glass portion is beveled inward of the rearward polymer portion.

According to a third aspect of the present disclosure, the electro-optic rearview mirror assembly of any one of the first through second aspects is presented, wherein the electrochromic element further comprises a seal sandwiched between the forward electrochromic substrate and the rearward electrochromic substrate, the seal surrounding the electrochromic medium, and the seal comprising: (a) an outward insulative portion forming at least a seal portion of the perimeter surface, the outward portion comprising a material that is substantially electrically insulative and substantially nontransparent, (b) a metallic strip inward from the outward insulative portion and not exposed at the perimeter surface, and (c) an inward insulative portion inward from the metallic strip, the inward portion comprising a material that is substantially electrically insulative and substantially nontransparent.

According to a fourth aspect of the present disclosure, the electro-optic rearview mirror assembly of the third aspect is presented, wherein at the contoured portion of the perimeter surface, (i) the forward electrochromic portion is substantially flush with the seal portion and (ii) the seal portion is substantially flush with the rearward electrochromic portion.

According to a fifth aspect of the present disclosure, the electro-optic rearview mirror assembly of any one of the third through fourth aspects is presented, wherein (a) the electrochromic element further comprises a spectral filter ring disposed (i) between the forward electrochromic substrate and the rearward electrochromic substrate and (ii) forward of the seal, and (b) the spectral filter ring is inward of the perimeter surface and not exposed at the perimeter surface.

According to a sixth aspect of the present disclosure, the electro-optic rearview mirror assembly of any one of the third through fifth aspects is presented, wherein the metallic strip extends along but separated from the seal portion of the perimeter surface at a top of the rearview element, a side of the rearview element, and a bottom of the rearview element.

According to a seventh aspect of the present disclosure, the electro-optic rearview mirror assembly of any one of the third through sixth aspects is presented, wherein the seal of the electrochromic element further comprises a second metallic strip inward from the outward insulative portion and not exposed at the perimeter surface, the second metallic strip separated from the metallic strip by a gap.

According to an eighth aspect of the present disclosure, the electro-optic rearview mirror assembly of the seventh aspect is presented, wherein the second metallic strip extends along but separated from the seal portion of the perimeter surface at a top of the rearview element, further from the side of the rearview element than the metallic strip.

According to a ninth aspect of the present disclosure, the electro-optic rearview mirror assembly of any one of the third through eighth aspects is presented, wherein the electrochromic element further comprises a clip that is electrically conductive in contact with the metallic strip of the seal.

According to a tenth aspect of the present disclosure, the electro-optic rearview mirror assembly of any one of the third through ninth aspects is presented, wherein (i) the material that is substantially electrically insulative and substantially nontransparent forms both the outward insulative portion of the seal and, contiguously, the inward insulative portion of the seal, and (ii) the metallic strip is sandwiched between the material that is substantially electrically insulative and substantially nontransparent and one of the forward electrochromic substrate and the rearward electrochromic substrate.

According to an eleventh aspect of the present disclosure, the electro-optic rearview mirror assembly of the tenth aspect is presented, wherein the seal further comprises a second metallic strip, the second metallic strip aligned with the metallic strip and sandwiched between the material that is substantially electrically insulative and substantially transparent and the other of the forward electrochromic substrate and the rearward electrochromic substrate.

According to a twelfth aspect of the present disclosure, the electro-optic rearview mirror assembly of any one of the first through eleventh aspects is presented, wherein the electrochromic element further comprises a reflective layer disposed between the forward electrochromic substrate and the rearward electrochromic substrate, rearward of the electrochromic medium.

According to a thirteenth aspect of the present disclosure, the electro-optic rearview mirror assembly of any one of the first through twelfth aspects is presented, wherein the rearward polymer substrate is substantially opaque to electromagnetic radiation throughout an entirety of the visible spectrum.

According to a fourteenth aspect of the present disclosure, the electro-optic rearview mirror assembly of any one of the first through thirteenth aspects is presented, wherein the rearview element further comprises ink printing disposed between the forward glass substrate and the forward polymer substrate along but separated from the perimeter surface of the rearview element.

According to a fifteenth aspect of the present disclosure, the electro-optic rearview mirror assembly of any one of the first through fourteenth aspects is presented, wherein (i) the rearward electrochromic substrate comprises an electrochromic recess where the perimeter surface at the rearward electrochromic substrate is disposed inward from the perimeter surface at the forward electrochromic substrate, and (ii) the rearview element further comprises a clip that extends along the forward primary surface of the rearward electrochromic substrate, over an edge of the rearward electrochromic substrate at the electrochromic recess, and along the rearward primary surface of the rearward electrochromic substrate.

According to a sixteenth aspect of the present disclosure, the electro-optic rearview mirror assembly of the fifteenth aspect is presented, wherein (i) the rearward polymer substrate comprises a polymer recess inset relative to the electrochromic recess, the polymer recess accommodating presence of the clip, and (ii) the rearward glass substrate comprises a glass recess inset relative to the electrochromic recess, the glass recess accommodating presence of the clip.

According to a seventeenth aspect of the present disclosure, the electro-optic rearview mirror assembly of the sixteenth aspect is presented, wherein the polymer recess and the glass recess are aligned with each other.

According to an eighteenth aspect of the present disclosure, the electro-optic rearview mirror assembly of any one of the first through seventeenth aspects further comprises: a mounting assembly to which the rearview element is coupled, the mounting assembly configured for mounting on a windshield or overhead space of a vehicle.

According to a nineteenth aspect of the present disclosure, the electro-optic rearview mirror assembly of the eighteenth aspect is presented, wherein the mounting assembly leaves an entirety of both (i) the forward polymer portion of the perimeter surface and (ii) the forward glass portion of the perimeter surface exposed to the external environment.

According to a twentieth aspect of the present disclosure, the electro-optic rearview mirror assembly of any one of the eighteenth through nineteenth aspects is presented, wherein at opposing sides and a bottom of the rearview element, the mounting assembly leaves an entirety of all of (i) the forward electrochromic portion of the perimeter surface, (ii) the rearward electrochromic portion of the perimeter surface, (iii) the rearward polymer portion of the perimeter surface, and (iv) the rearward glass portion of the perimeter surface exposed to the external environment.

According to a twenty-first aspect of the present disclosure, the electro-optic rearview mirror assembly of any one of the eighteenth through twentieth aspects is presented, wherein the mounting assembly covers electrical connections to the electrochromic element but leaves more than half of the area of the rearward primary surface of the rearward glass substrate exposed to the external environment.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. An electro-optic rearview mirror assembly comprising:
a rearview element comprising:
a perimeter surface;
a forward electrochromic substrate having a forward primary surface and a rearward primary surface, the forward electrochromic substrate forming a forward electrochromic portion of the perimeter surface;
a rearward electrochromic substrate having a forward primary surface and a rearward primary surface, the rearward electrochromic substrate forming a rearward electrochromic portion of the perimeter surface;
an electrochromic medium sandwiched between the forward electrochromic substrate and the rearward electrochromic substrate;
a forward polymer substrate disposed forward of the forward electrochromic substrate, the forward polymer substrate forming a forward polymer portion of the perimeter surface, the forward polymer substrate contacting and at least partially covering the forward primary surface of the forward electrochromic substrate, the forward polymer substrate comprising a forward primary surface and a rearward primary surface facing away from forward primary surface of the forward polymer substrate and facing the forward primary surface of the forward electrochromic substrate;
a forward glass substrate disposed forward of the forward polymer substrate, the forward glass substrate forming a forward glass portion of the perimeter surface, the forward glass substrate contacting and at least partially covering the forward primary surface of the forward polymer substrate, the forward glass substrate comprising a forward primary surface and a rearward primary surface facing away from the forward primary surface of the forward glass substrate and facing the forward primary surface of the forward polymer substrate layer;
a rearward polymer substrate disposed rearward of the rearward electrochromic substrate, the rearward polymer substrate forming a rearward polymer portion of the perimeter surface, the rearward polymer substrate contacting and at least partially covering the rearward primary surface of the rearward electrochromic substrate, the rearward polymer substrate comprising a forward primary surface facing the rearward primary surface of the rearward electrochromic substrate and a rearward primary surface facing away from the forward primary surface of the rearward polymer substrate; and
a rearward glass substrate disposed rearward of the rearward polymer substrate, the rearward glass substrate forming a rearward glass portion of the perimeter surface, the rearward glass substrate contacting and at least partially covering the rearward primary surface of the rearward polymer substrate, the rearward glass substrate comprising a forward primary surface facing the rearward primary surface of the rearward polymer substrate and a rearward primary surface facing away from the forward primary surface of the rearward glass substrate;
wherein, the perimeter surface has a contoured portion where (i) the forward polymer portion is substantially flush with the forward electrochromic portion, (ii) the forward glass portion is substantially flush with the forward polymer portion, (iii) the rearward polymer portion is substantially flush with the rearward electrochromic portion, and (iv) the rearward glass portion is substantially flush with the rearward polymer portion, and
wherein, the contoured portion of the perimeter surface is exposed to an external environment and the electro-optic rearview mirror assembly lacks an element covering the contoured portion.

2. The electro-optic rearview mirror assembly of claim 1, wherein the forward glass portion is beveled inward of the forward polymer portion,
the forward polymer portion is beveled inward of the forward electrochromic portion,
the rearward polymer portion is beveled inward of the rearward electrochromic portion, and the rearward glass portion is beveled inward of the rearward polymer portion.

3. The electro-optic rearview mirror assembly of claim 1, wherein
the electrochromic element further comprises a seal sandwiched between the forward electrochromic substrate and the rearward electrochromic substrate, the seal surrounding the electrochromic medium, and the seal comprising:
an outward insulative portion forming at least a seal portion of the perimeter surface, the outward portion comprising a material that is substantially electrically insulative and substantially nontransparent,
a metallic strip inward from the outward insulative portion and not exposed at the perimeter surface, and
an inward insulative portion inward from the metallic strip, the inward portion comprising a material that is substantially electrically insulative and substantially nontransparent.

4. The electro-optic rearview mirror assembly of claim 3, wherein at the contoured portion of the perimeter surface, (i) the forward electrochromic portion is substantially flush with the seal portion and (ii) the seal portion is substantially flush with the rearward electrochromic portion.

5. The electro-optic rearview mirror assembly of claim 3, wherein
the electrochromic element further comprises a spectral filter ring disposed (i) between the forward electrochromic substrate and the rearward electrochromic substrate and (ii) forward of the seal, and
the spectral filter ring is inward of the perimeter surface and not exposed at the perimeter surface.

6. The electro-optic rearview mirror assembly of claim 3, wherein
the metallic strip extends along but separated from the seal portion of the perimeter surface at a top of the rearview element, a side of the rearview element, and a bottom of the rearview element.

7. The electro-optic rearview mirror assembly of claim 3, wherein
the seal of the electrochromic element further comprises a second metallic strip inward from the outward insulative portion and not exposed at the perimeter surface, the second metallic strip separated from the metallic strip by a gap.

8. The electro-optic rearview mirror assembly of claim 7, wherein the second metallic strip extends along but separated from the seal portion of the perimeter surface at a top of the rearview element, further from the side of the rearview element than the metallic strip.

9. The electro-optic rearview mirror assembly of claim 3, wherein the electrochromic element further comprises a clip that is electrically conductive in contact with the metallic strip of the seal.

10. The electro-optic rearview mirror assembly of claim 3, wherein
the material that is substantially electrically insulative and substantially nontransparent forms both the outward insulative portion of the seal and, contiguously, the inward insulative portion of the seal, and
the metallic strip is sandwiched between the material that is substantially electrically insulative and substantially nontransparent and one of the forward electrochromic substrate and the rearward electrochromic substrate.

11. The electro-optic rearview mirror assembly of claim 10, wherein
the seal further comprises a second metallic strip, the second metallic strip aligned with the metallic strip and sandwiched between the material that is substantially electrically insulative and substantially transparent and the other of the forward electrochromic substrate and the rearward electrochromic substrate.

12. The electro-optic rearview mirror assembly of claim 1, wherein
the electrochromic element further comprises a reflective layer disposed between the forward electrochromic substrate and the rearward electrochromic substrate, rearward of the electrochromic medium.

13. The electro-optic rearview mirror assembly of claim 1, wherein
the rearward polymer substrate is substantially opaque to electromagnetic radiation throughout an entirety of the visible spectrum.

14. The electro-optic rearview mirror assembly of claim 1, wherein
the rearview element further comprises ink printing disposed between the forward glass substrate and the forward polymer substrate along but separated from the perimeter surface of the rearview element.

15. The electro-optic rearview mirror assembly of claim 1, wherein
the rearward electrochromic substrate comprises an electrochromic recess where the perimeter surface at the rearward electrochromic substrate is disposed inward from the perimeter surface at the forward electrochromic substrate, and
the rearview element further comprises a clip that extends along the forward primary surface of the rearward electrochromic substrate, over an edge of the rearward electrochromic substrate at the electrochromic recess, and along the rearward primary surface of the rearward electrochromic substrate.

16. The electro-optic rearview mirror assembly of claim 15, wherein
the rearward polymer substrate comprises a polymer recess inset relative to the electrochromic recess, the polymer recess accommodating presence of the clip, and
the rearward glass substrate comprises a glass recess inset relative to the electrochromic recess, the glass recess accommodating presence of the clip.

17. The electro-optic rearview mirror assembly of claim 16, wherein the polymer recess and the glass recess are aligned with each other.

18. The electro-optic rearview mirror assembly of claim 1 further comprising:
a mounting assembly to which the rearview element is coupled, the mounting assembly configured for mounting on a windshield or overhead space of a vehicle.

19. The electro-optic rearview mirror assembly of claim 18, wherein
the mounting assembly leaves an entirety of both (i) the forward polymer portion of the perimeter surface and (ii) the forward glass portion of the perimeter surface exposed to the external environment.

20. The electro-optic rearview mirror assembly of claim 18, wherein
at opposing sides and a bottom of the rearview element, the mounting assembly leaves an entirety of all of (i) the forward electrochromic portion of the perimeter surface, (ii) the rearward electrochromic portion of the perimeter surface, (iii) the rearward polymer portion of the perimeter surface, and (iv) the rearward glass portion of the perimeter surface exposed to the external environment, and
the mounting assembly covers electrical connections to the electrochromic element but leaves more than half of the area of the rearward primary surface of the rearward glass substrate exposed to the external environment.

21. (canceled)
